(19) United States
(12) Patent Application Publication
(10) Pub. No.: US 2026/0104897 A1
(43) Pub. Date: Apr. 16, 2026

(54) Non-Volatile Memory Boot Partition Smart Cache for Faster Platform Boot

(71) Applicant: Dell Products L.P., Round Rock, TX (US)

(72) Inventors: Gowtham Moorthy, Thanjavur (IN); Xiaomei Zhu, Round Rock, TX (US); Shekar Babu Suryanarayana, Bangalore (IN)

(21) Appl. No.: 18/911,458

(22) Filed: Oct. 10, 2024

(51) Int. Cl. G06F 9/4401

(52) U.S. Cl. CPC G06F 9/4406; G06F 9/4403

(57) ABSTRACT

A firmware management operation. The firmware management operation includes providing an information handling system with a distributed unified BIOS, the distributed unified BIOS comprising a firmware component, identifying a processor environment installed on an information handling system from a plurality of processor environments, the processor environment comprising a processor architecture, and performing a boot path management operation, the boot path management operation managing a memory storage location of the firmware component during an information handling system boot process.

### BACKGROUND OF THE INVENTION

### FIELD OF THE INVENTION

The present invention relates to information handling systems. More specifically, embodiments of the invention relate to performing a firmware management operation.

### DESCRIPTION OF THE RELATED ART

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment the invention relates to a computer-implementable method for performing a firmware management operation, comprising: providing an information handling system with a distributed unified BIOS, the distributed unified BIOS comprising a firmware component, identifying a processor environment installed on an information handling system from a plurality of processor environments, the processor environment comprising a processor architecture, and performing a boot path management operation, the boot path management operation managing a memory storage location of the firmware component during an information handling system boot process.

In another embodiment the invention relates to a system comprising: a processor; a data bus coupled to the processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: providing an information handling system with a distributed BIOS; identifying a processor environment installed on an information handling system from a plurality of processor environments; performing a boot path management operation, the boot path management operation managing a memory storage location of the firmware component during an information handling system boot process.

In another embodiment the invention relates to a computer-readable storage medium embodying computer program code, the computer program code comprising computer executable instructions configured for: providing an information handling system with a distributed BIOS; identifying a processor environment installed on an information handling system from a plurality of processor environments; performing a boot path management operation, the boot path management operation managing a memory storage location of the firmware component during an information handling system boot process.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system (IHS) as implemented in the system and method of the present invention;

FIG. 2 shows a simplified block diagram of multi-processor operating environment;

FIG. 3 shows a simplified block diagram of an architecture-specific distributed firmware management platform;

FIGS. 4a through 4c are a simplified block diagram showing the performance of certain distributed firmware management operations;

FIGS. 5a and 5b are a simplified block diagram showing the performance of certain boot path management operations to boot an associated IHS;

FIGS. 6a and 6b are a simplified block diagram showing the use of one or more boot path cache (BPC) operations to facilitate the performance of certain boot path management operations; and

FIG. 7 shows a Basic Input/Output System (BIOS) context cache (BCC) table used to facilitate the performance of certain BPC operations.

### DETAILED DESCRIPTION

A system, method, and computer-readable medium are disclosed for performing a firmware management operation, described in greater detail herein. Various aspects of the invention reflect an appreciation that it is not uncommon for certain firmware components of a Basic Input/Output System (BIOS) associated with an information handling system (IHS) to be added, deleted, updated, revised, replaced, or restored over time. Likewise, various aspects of the invention reflect an appreciation that such BIOS firmware components are often added, deleted, updated, revised, replaced, or restored to provide security updates, fix known software bugs, improve performance, add new features and functionalities, and so forth.

Various aspects of the invention reflect an appreciation that it is not uncommon for an IHS to be implemented with an embedded controller (EC), familiar to skilled practitioners of the art. Likewise, various aspects of the invention reflect an appreciation that an EC, as typically implemented, may be used to perform a variety of IHS-related tasks. One such use is for the EC to gain control of the IHS during the power-on phase of its boot process and load the instruction pointer of its processor, which is then pointed to the location of its associated Basic Input/Output System (BIOS) code within Serial Peripheral Interface (SPI) flash memory implemented in the IHS.

Accordingly, various aspects of the invention reflect an appreciation that the IHS’s BIOS will execute directly from SPI flash memory, as its Random Access Memory (RAM) and other memory has not yet been initialized. Likewise, Security (SEC) pre-boot phase code may be implemented in various embodiments to initialize the IHS’s chipset Cache as RAM (CAR), such that stack and heap operations can be performed. If so, then the BIOS of the IHS will execute directly from SPI flash memory such that the IHS’s various memory components may be discovered and initialized during Pre Extensible Firmware Interface (EFI) Initialization (PEI) pre-boot phase operations. Thereafter, once the IHS’s memory components have been discovered and initialized, then its associated BIOS code may be cached from SPI Flash to RAM.

However, various aspects of the invention reflect an appreciation that caching SPI flash memory content to an IHS’s main memory during every boot takes additional time (e.g., 500ms to 1 sec), since reading from SPI flash can be time consuming. As a result, overall time for an IHS to boot may be increased. Likewise, various aspects of the invention reflect an appreciation that there is currently no known approach for providing an intelligent, staged cache mechanism available as single compressed image residing in SPI flash memory. Furthermore, no current approach is known for caching only critical and required content to memory based upon different boot modes. Accordingly, various aspects of the invention likewise reflect an appreciation that typical one-time caches of an IHS’s entire BIOS may delay its boot, due to the inability to select only a predetermined portion of BIOS firmware for caching.

For purposes of this disclosure, an information handling system (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, read-only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

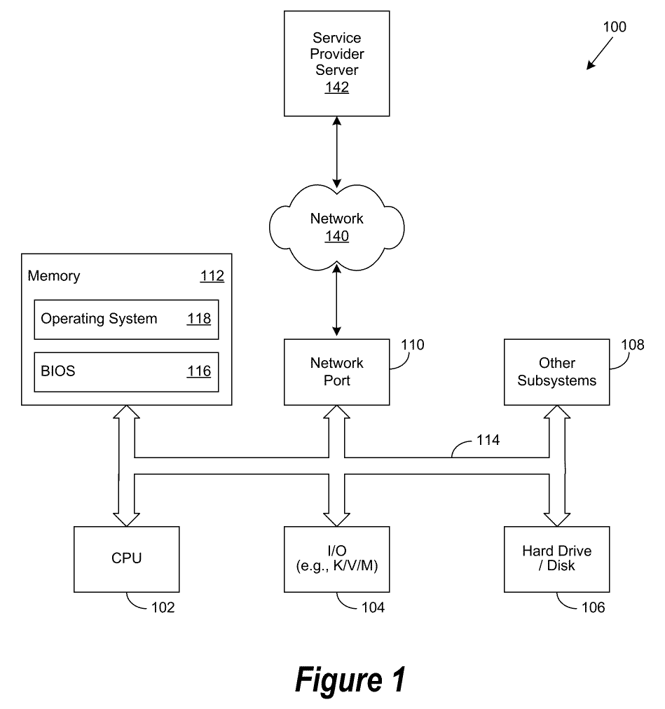

FIG. 1 is a generalized illustration of an information handling system that can be used to implement the system and method of the present invention. In certain embodiments, the information handling system (IHS) 100 may be implemented to include a processor (e.g., central processor unit or “CPU”) 102, various input/output (I/O) devices 104, such as a display, a keyboard, a mouse, a touchpad, or a touchscreen, and associated controllers, a hard drive or disk storage 106, and various other subsystems 108. In various embodiments, the IHS 100 may also be implemented to include a network port 110 operable to connect to a network 140, which in turn may be implemented to provide access to a service provider server 142. In various embodiments, the IHS 100 may likewise be implemented to include system memory 112, which is interconnected to the foregoing via one or more buses 114.

In various embodiments, system memory 112 may be configured to store program code, or data, or both, which in turn may be implemented to be accessible and executable by the CPU 102. In various embodiments, system memory 112 may be implemented using any suitable memory technology. Examples of such memory technology include random access memory (RAM), static RAM (SRAM), dynamic RAM (DRAM), synchronous dynamic RAM (SDRAM), non-volatile RAM (NVRAM), read-only memory (ROM), erasable programmable read-only memory (EPROM), electrically erasable programmable ROM (EEPROM), complementary metal-oxide-semiconductor (CMOS) memory, flash memory, or any other type of computer memory, whether it may be volatile or non-volatile. In various embodiments, system memory 112 may include one or more dual in-line memory modules (DIMMs), each containing one or more RAM modules mounted onto an integrated circuit board.

In various embodiments the system memory 112 may further be implemented to include a Basic Input/Output System (BIOS) 116, or an operating system (OS) 118, or both. Skilled practitioners of the art will be aware that BIOS 116, also known as System BIOS, ROM BIOS, or personal computer (PC) BIOS, is a type of firmware used to provide runtime services for an OS 118 to perform hardware initialization during the booting process of an IHS 100. Those of skill in the art will likewise be aware that firmware is a combination of persistent memory, program code, and data that provides low-level control of an IHS’s 100 hardware. In various embodiments, the BIOS 116 may be implemented to initialize and test certain hardware components of its associated IHS 100 during the booting process (e.g., Power-On Self-Test, or “POST”), followed by loading a boot loader from a particular mass storage device, which in turn may then be used to initialize a kernel.

In various embodiments, such BIOS 116 firmware may be implemented to provide hardware abstraction services to higher-level software such as an OS 118. In various embodiments, BIOS 116 firmware may be implemented in a less complex IHS 100 as an OS 118, performing all control, monitoring, and data manipulation functions. In various embodiments, certain components of a particular IHS 100 may be implemented to have its own firmware, which may store operational variables, data structures, or in general, any sort of information.

In various embodiments, NVRAM may be implemented to store a BIOS 116 associated with the IHS 100. In various embodiments, the NVRAM may also be implemented to hold the initial processor instructions required to bootstrap the IHS 100, store calibration constants, passwords, or setup information, or a combination thereof. In various embodiments, such setup information may be stored as variables in the NVRAM such that the variables are available during system boot from a power-off state. Various embodiments of the invention reflect an appreciation that such variables may need to be modified, revised, updated, restored, or replaced from time to time if they become corrupted. In various embodiments, an NVRAM driver may be implemented to use NVRAM headers to initialize and enable read/write services for updating or restoring such variables. Accordingly, as it relates to various embodiments of the invention, the terms “firmware,” “NVRAM,” or “BIOS” may be used generically and interchangeably.

In various embodiments, the functionality of a BIOS 116 may be implemented according to the Unified Extensible Firmware Interface (UEFI) specification, which describes how an IHS’s 100 firmware interacts with a particular OS 118. Various embodiments of the invention reflect an appreciation that UEFI, as typically implemented, may offer certain features and benefits that are not available from traditional BIOS 116 implementations, such as faster boot times, improved security, support for larger storage devices, and higher definition graphical user interfaces (GUIs). In addition, UEFI stores all data related to the IHS’s 100 initialization and startup within an .efi file, rather than on its associated firmware. In typical implementations, the .efi file may be stored on a special memory partition known as an EFI System Partition (ESP), which also contains the IHS’s 100 bootloader.

In various embodiments, BIOS 116 may be instantiated as a distributed BIOS 116. As used herein, a distributed BIOS 116 broadly refers to a BIOS 116 that includes a plurality of BIOS 116 components, or a plurality of BIOS 116 variables, or a plurality of BIOS 116 storage locations, or a combination thereof. In various embodiments, the distributed BIOS 116 may be implemented to function with any of a plurality of processor environments, described in greater detail herein. In certain embodiments, the distributed BIOS 116 may be implemented as a distributed unified BIOS. As used herein, a distributed unified BIOS 116 broadly refers to a BIOS 116 that includes a plurality of BIOS 116 components, or a plurality of BIOS 116 variables, or a plurality of BIOS 116 storage locations, or a combination thereof, which are implemented to function with any of a plurality of processor environments, described in greater detail herein.

In various embodiments, the IHS 100 may be implemented to perform a firmware management operation. As used herein, a firmware management operation broadly refers to any task, function, operation, procedure, or process performed, directly or indirectly, to store, retrieve, aggregate, disaggregate, add, delete, modify, revise, update, replace, or restore one or more individual BIOS 116 components, described in greater detail herein, or one or more individual BIOS 116 variables, likewise described in greater detail herein, or a combination thereof, in one or more memory 112 locations associated with a particular IHS 100. In various embodiments, the firmware management operation may be implemented to include the performance of a boot path cache operation. A boot path cache (BPC) operation, as used herein, broadly refers to any function, task, procedure, or process performed, directly or indirectly, within a multi-processor operating environment, or an architecture-specific distributed firmware management platform (ASDFMP), both of which are described in greater detail herein, to manage the memory storage location of one or more firmware components, and the sequence of their respective use, by an IHS 100 during its boot process.

In various embodiments, the one or more firmware components may be stored in volatile memory, or non-volatile memory, or a combination thereof, implemented within an IHS 100. In various embodiments, the non-volatile memory implemented within an IHS 100 may include Serial Peripheral Interface (SPI) flash memory, or Non-Volatile Memory Express (NVMe) memory, or a combination thereof. In various embodiments, the non-volatile memory of an IHS 100 may be implemented to include a boot partition (BP), described in greater detail herein. In certain of these embodiments, the one or more firmware components may be stored in a BP of an IHS’s 100 non-volatile memory.

In various embodiments, copies of the one or more firmware components may be stored in two or more memory storage locations of the IHS 100. As an example, one copy of a firmware component may be stored in an IHS’s 100 RAM memory, while a second copy of the same firmware component may be stored in a BP implemented within its NVMe memory. In various embodiments, the memory location used to store a particular firmware component, and whether it is stored in more than one memory location, concurrently or otherwise, is a matter of design choice.

In various embodiments, a firmware component may be implemented as a BIOS 116 image file, or one or more individual components thereof, or a firmware component payload of one or more individual firmware component files, or a combination thereof. In various embodiments, the determination of the sequence that each firmware component is executed during the boot sequence of an associated IHS 100, and the selection of the memory location it may be respectively stored in, is a matter of design choice. In certain embodiments, the firmware management operation may be performed during operation of an IHS 100. In various embodiments, performance of the firmware management operation may result in the realization of improved operation of an IHS 100.

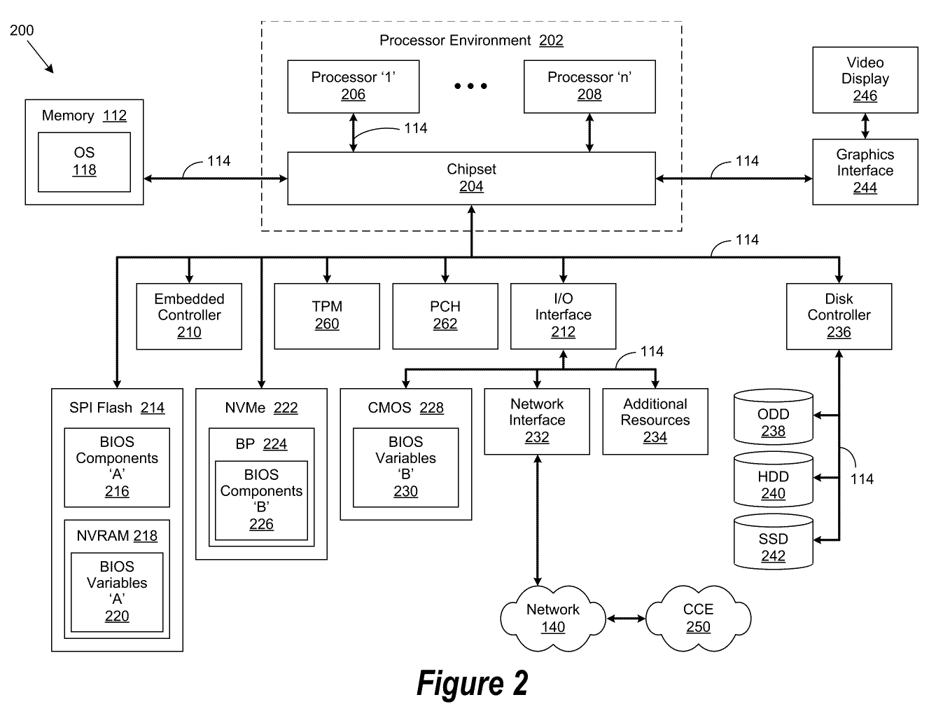

FIG. 2 shows a simplified block diagram of multi-processor operating environment implemented in accordance with an embodiment of the invention. As used herein, a multi-processor operating environment 200, such as that shown in FIG. 2, broadly refers to any instrumentality, or aggregate of instrumentalities, that may be implemented to compute, classify, process, transmit, receive, retrieve, originate, switch, store, display, manifest, detect, record, reproduce, handle, or utilize, or a combination thereof, any form of information, intelligence, or data for business, scientific, control, entertainment, or other purpose, through the use of a particular processor environment (PE) 202. For example, the multi-processor environment 200 may be implemented as an information handling system (IHS), described in greater detail herein, such as a personal computer, a laptop computer, a smart phone, a tablet computer or other consumer electronic device, a network server, a network storage device, or other network communication device, and so forth. In various embodiments, a multi-processor operating environment 200 may be implemented to include processing resources for executing machine-executable code, such as a central processing unit (CPU), a programmable logic array (PLA), an embedded device such as a System-on-a-Chip (SoC), or other control logic hardware.

In various embodiments, the multi-processor operating environment 200 may be implemented to include a PE 202. In various embodiments, the PE 202 may be implemented to include a chipset 204 and one or more processors ‘1’ 206 through ‘n’ 208. In various embodiments, the processors ‘1’ 206 through ‘n’ 208 implemented within a PE 202 may have the same, or different, architectures. In various embodiments, a chipset 204 may be implemented to support one or more architectures corresponding to the processors ‘1’ 206 through ‘n’ 208. In various embodiments, the one or more architectures can include an x86 type processor architecture, an Advanced Reduced Instruction Set Computer (RISC) Machines (ARM) type processor architecture, or a combination thereof. In various embodiments, a processor environment implementing an x86 type processor architecture provides an x86 type processor environment. In various embodiments, a processor environment implementing an ARM type processor architecture provides an ARM type processor environment.

As an example, processors ‘1’ 206 through ‘n’ 208 of a particular PE 202 may be implemented to be the same in a server. In this example, each processor may be assigned to be a resource to one or more virtual machines (VMs). As another example, processor ‘1’ 206 may be implemented as a multi-core processor in a graphics work station, while processor ‘n’ 208 may be implemented a Graphics Processing Unit (GPU), familiar to skilled practitioners of the art. As another example, one or more of processors ‘1’ 206 through ‘n’ 208 of a particular PE 202 may be implemented as an Application Processing Unit (APU) type processor. Alternately, an APU type processor may be implemented as a separate component within the multi-processor operating environment 200.

In various embodiments, each of the processors ‘1’ 206 through ‘n’ 208 of a particular PE 202 may be implemented to run the same OS 118. Likewise, individual processors ‘1’ 206 through ‘n’ 208 of a particular PE 202 may be implemented in various embodiments to run a different same OS 118. For example, processor ‘1’ 206 may be implemented to run Microsoft^{®} Windows^{®}, while processor ‘n’ 208 may be implemented to run a version of Linux^{®}.

In various embodiments, one or more PEs 202 selected from a plurality of PEs 202 may be implemented within the multi-processor operating environment 200. In certain of these embodiments, a particular PE 202 selected from a plurality of PEs 202 may be vendor-specific. In various embodiments, a particular PE 202 selected from a plurality of PEs 202 may be implemented as a System on a Chip (SoC), familiar to those of skill in the art. In various embodiments, the PE 202 may be implemented to include a plurality of vendor-specific SoCs provided by different vendors, or different versions of an SoC provided by the same vendor.

In various embodiments, the multi-processor operating environment 200 may likewise be implemented to include system memory 112. In various embodiments, the system memory 112 may in turn be implemented to include an operating system (OS) 118. In various embodiments, the multi-processor operating environment 200 may be implemented to include an embedded controller (EC) 210, a Trusted Platform Module (TPM) 260, a Platform Controller Hub (PCH) 262, an input/output (I/O) interface 212, a disk controller 236, and a graphics interface 244, or a combination thereof.

In various embodiments, the multi-processor operating environment 200 may likewise be implemented to include Nonvolatile Random Access Memory (NVRAM) 218, Serial Peripheral Interface (SPI) Flash memory 214, Nonvolatile Memory Express (NVMe) 222 memory, and a complementary metal-oxide-semiconductor (CMOS) 228 chip, or a combination thereof. Skilled practitioners of the art will be familiar with NVRAM 218, which in general usage broadly refers to Random Access Memory (RAM) that retains data if power is lost. In various embodiments, NVRAM 218 may be implemented to hold initial processor instructions used to bootstrap an information handling system (IHS), described in greater detail herein. In various embodiments, NVRAM 218 may be implemented in the form of flash memory, such as SPI Flash 214 memory, Erasable Programmable Read-Only Memory (EPROM), Electrically Erasable Programmable Read-Only Memory (EEPROM), or Ferroelectric RAM (F-RAM), Magnetoresistive RAM (MRAM), Phase-Change RAM (PRAM), or a combination thereof.

Those of skill in the art will likewise be familiar with SPI Flash 214 memory, which is a type of EEPROM memory implemented in accordance with the SPI standard, where the data stored within it is architecturally arranged in blocks. Various embodiments of the invention reflect an appreciation that while data stored within SPI Flash memory 214 is erased at the block level, it may be read or written at the byte level. Likewise, various embodiments of the invention reflect an appreciation that the ability to erase blocks of data within SPI Flash 214 memory may be advantageous in certain embodiments as erase speeds can be improved, and as a result, allow information to be stored more efficiently and compactly.

Likewise, skilled practitioners of the art will be familiar with NVMe, which is an open, logical device interface specification for accessing non-volatile storage media implemented within an IHS. Certain embodiments of the invention reflect an appreciation that NVMe 222 memory is currently available in various form factors, such as solid state drives (SSDs), Peripheral Component Interconnect Express (PCIe) memory cards, and M.2 memory cards. Various embodiments of the invention likewise reflect an appreciation that NVMe, as a logical device interface, is able to support low latency and internal parallelism for solid state storage devices, which can reduce Input/Output (I/O) overhead while providing other known performance improvements.

In various embodiments, the SPI Flash 214 memory may be implemented to receive, store, manage, and provide access to one or more Basic Input/Output System (BIOS) components ‘A’ 216. As used herein, a BIOS component broadly refers to one or more discrete portions of firmware program code that may be used, directly or indirectly, by a BIOS during its operation. In various embodiments, the SPI Flash 214 memory may be implemented to include certain NVRAM 218 memory. In various embodiments, the NVRAM 218 memory may in turn be implemented to receive, store, manage, and provide access to one or more BIOS variables ‘A’ 220, such as configuration settings, for use by the BIOS of an associated IHS.

In various embodiments, the NVMe 222 memory may be implemented to include a boot partition (BP) 224. Those of skill in the art will be familiar with the concept of a BP 224, which in common usage broadly refers to a primary memory partition that contains a boot loader, which is a portion of program code responsible for booting the OS 118 of an associated IHS. In various embodiments, the BP 224 may in turn be implemented to receive, store, manage, and provide access to one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226.

In various embodiments, the I/O interface 212 may be implemented to interact with a complementary metal-oxide semiconductor (CMOS) 228 chip. In various embodiments, the CMOS 228 chip may be implemented to include a real-time clock and RAM memory that is backed-up by a battery. In various embodiments, the memory in the CMOS 228 chip may be implemented to receive, store, manage, and provide access to one or more BIOS variables ‘B’ 230.

In various embodiments, the I/O interface 212 may likewise be implemented to interact with a network interface 232, or additional resources 234. or both. In various embodiments, the network interface 232 may be implemented to provide access and connectivity to a network 140. In turn, the network 140 may be implemented in various embodiments to provide access and connectivity to a cloud computing environment (CCE) 250. Skilled practitioners of the art will be familiar with cloud computing, which is defined by the National Institute of Standards and Technology (NIST) as a model for enabling ubiquitous, convenient, on-demand network access to a shared pool of configurable computing resources (e.g., networks, servers, storage, applications, portions of program code, firmware components, data, services, and so forth) that can be rapidly provisioned and released with minimal management effort or service provider interaction.

In various embodiments, additional resources 234 may include a data storage system, additional graphics interfaces, a network interface card (NIC), a sound or video processing card, and so forth. In various embodiments, additional resources 234 may be implemented on a main circuit board of an IHS, or a separate circuit board or add-in card thereof, or a device that is external to the IHS, or a combination thereof. In various embodiments, the disk controller 236 may be implemented to interact with, and manage access to and from, an optical disk drive (ODD) 238, a hard disk drive (HDD) 240, or a solid state drive (SSD) 242, or a combination thereof.

In various embodiments, the graphics interface 242 may be implemented to present visual content on an associated video display. In certain of these embodiments, the graphics interface 242 may likewise be implemented to receive user gesture input from the video display 244, such as through the use of a touch-sensitive screen. In various embodiments, the system memory 112, the chipset 204, one or more processors ‘1’ 206 through ‘n’ 208, the EC 210, the TPM 260, the PCH 262, the SPI Flash 214 memory, the NVMe 222 memory, the I/O interface 212, the CMOS 228 chip, the network interface 232, the additional resources 234, the disk controller 236, the ODD 238, the HDD 240, the SSD 242, the graphics interface 244, and the video display 246 may be implemented to provide and receive data to and from one another via one or more buses 114.

In various embodiments, a firmware management operation may be implemented to include a distributed firmware management operation. As used herein, a distributed firmware management operation broadly refers to a firmware management operation, described in greater detail herein, performed directly, or indirectly, within a multi-processor operating environment 200 to store, retrieve, aggregate, disaggregate, add, delete, modify, revise, update, replace, or restore one or more BIOS components ‘A’ 216 or ‘B’ 226, or one or more BIOS variables ‘A’ 220 or ‘B’ 230, or a combination thereof. In various embodiments, one or more BIOS components ‘A’ 216 or ‘B’ 226, or one or more BIOS variables ‘A’ 220 or ‘B’ 230, or a combination thereof, may be used, individually or in combination with one another, in the performance of a distributed firmware management operation. In various embodiments, performance of the distributed firmware management operation effectively decouples (i.e., minimizes the interrelationship between) one or more BIOS components ‘A’ 216 or ‘B’ 226, or one or more BIOS variables ‘A’ 220 or ‘B’ 230, or a combination thereof, from each other. In various embodiments, the performance of the distributed firmware management operation effectively decouples PE BIOS components from other platform BIOS components, as described herein.

In various embodiments, individual BIOS components ‘A’ 216 or ‘B’ 226 used in the performance of one or more distributed firmware management operations may be located within, or outside of, the multi-processor operating environment 200. As an example, a particular BIOS component ‘A’ 216 or ‘B’ 226 may initially be stored within a cloud computing environment (CCE) 250, described in greater detail herein. In this example, the firmware component may be retrieved from the CCE 250 by the multi-processor operating environment 200 and then respectively stored as firmware components ‘A’ 216 in NVRAM 218, or ‘B’ 226 in NVMe 222 memory, or a combination of the two.

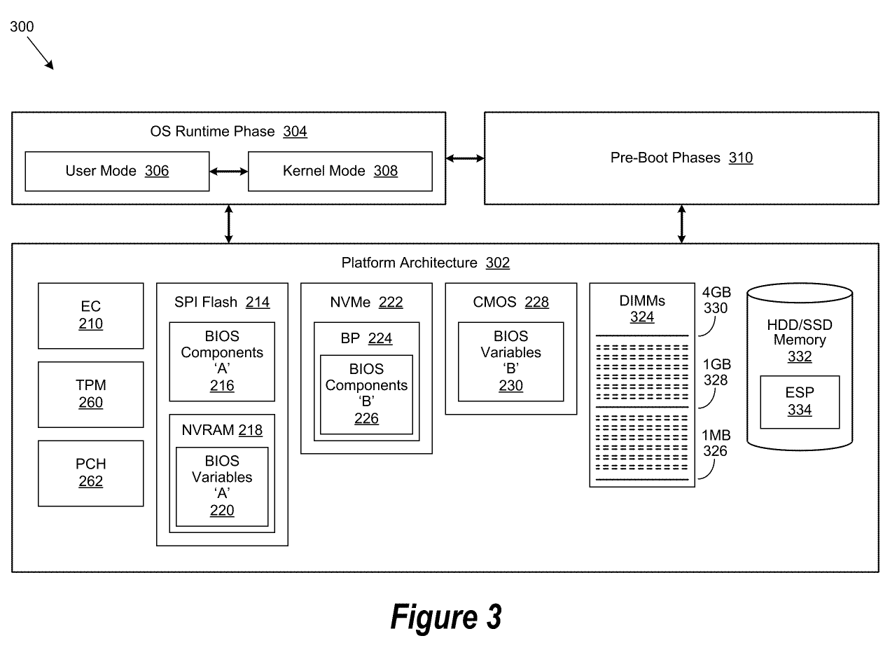

FIG. 3 shows a simplified block diagram of an architecture-specific distributed firmware management platform implemented in accordance with an embodiment of the invention. In various embodiments, the architecture-specific distributed firmware management platform (ASDFMP) 300, and its associated operation, may be implemented to accommodate architecture-specific aspects of a particular information handling system (IHS), described in greater detail herein. As an example, various IHS’s may utilize different processors (e.g., Intel^{®}, AMD^{®}, Qualcom^{®}, Broadcom^{®}, NVidia^{®}, and so forth), and as a result, may require the use of a Basic Input/Output System (BIOS) specific to their respective architecture, or associated operating system (OS), or both, at boot time. In various embodiments, the ASDFMP 300 may be implemented to perform one or more firmware management operations, described in greater detail herein.

In various embodiments, the ASDFMP 300 may be implemented to include a platform architecture 302. In certain of these embodiments, the platform architecture 302 may be implemented to include an embedded controller (EC) 210, a Trusted Platform Module (TPM) 260, a Platform Controller Hub (PCH) 262, Serial Peripheral Interface (SPI) Flash 214 memory, Nonvolatile Memory Express (NVMe) 222 memory, and a complementary metal-oxide-semiconductor (CMOS) 228 chip, or a combination thereof, each of which may be considered a component of an information handling system (IHS), as described in greater detail herein. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the EC 210 may be implemented, directly or indirectly, within the ASDFMP 300 to provide a root of trust function. As used herein, a root of trust broadly refers to a highly reliable component, such as an EC 210, that performs specific, important security functions. In various embodiments, a root of trust component may be implemented as a building block upon which other components of the ASDFMP 300 can derive security functions.

In various embodiments, the EC 210 may be implemented to perform a root of trust operation. As used herein, a root of trust operation broadly refers to a distributed firmware management operation, described in greater detail herein, performed directly, or indirectly, within an ASFDMP 300 to provide a root of trust by leveraging a secure interface to ensure integrity and security of communication between certain components of the ASDFMP 300. In various embodiments, one or more root of trust operations may be performed to enhance the security and trustworthiness of the ASDFMP 300.

Skilled practitioners of the art will be familiar with a TPM 260, which is an international standard for a secure crypto processor, typically implemented as a dedicated microcontroller designed to secure various hardware components of an ASDFMP 300 through the use of integrated cryptographic keys. In various embodiments, a TPM 260 may be implemented to increase the security of an ASDFMP 300 and to protect it against certain firmware attacks. In various embodiments, a TPM 260 may be implemented in combination with an EC 210 to perform a root of trust operation.

Those of skill in the art will likewise be familiar with a PCH 262, which broadly refers to a family of chipsets manufactured by Intel^{®} to control certain data paths and support functions used in conjunction with Intel^{®} processors. However, as used herein, a PCH 262 may broadly refer to one or more processor-agnostic functionalities of an ASDFMP 300 that may be used, directly or indirectly within it, to control various data paths and support functions associated with a particular processor. Examples of such processors include those manufactured by Intel^{®}, AMD^{®}, Qualcomm^{®}, Broadcom^{®}, NVidia^{®}, and so forth. Accordingly, various embodiments of the invention reflect an appreciation that provision of such PCH 262 functionalities may require a different implementation for each processor architecture.

In various embodiments, the SPI Flash 214 memory may be implemented to receive, store, manage, and provide access to one or more BIOS components ‘A’ 216, as described in greater detail herein. In various embodiments, the SPI Flash 214 memory may likewise be implemented to include certain NVRAM 218 memory. In various embodiments, the NVRAM 218 memory may in turn be implemented to receive, store, manage, and provide access to one or more BIOS variables ‘A’ 220, as described in greater detail herein.

In various embodiments, the NVMe 222 memory may be implemented to include a boot partition (BP) 224, described in greater detail herein. In various embodiments, the BP 224 may in turn be implemented to receive, store, and provide access to, one or more BIOS components ‘B’ 226. In various embodiments, the NVMe 222 memory may be implemented without a BP 224. Nonetheless, the NVMe 222 memory may be implemented in certain of these embodiments to still receive, store, manage, and provide access to one or more BIOS components ‘B’ 226. In various embodiments, as likewise described in greater detail herein, the CMOS 228 chip may be implemented to receive, store, and provide access to, one or more BIOS variables ‘B’ 230.

In various embodiments, the one or more DIMMs 324 may be implemented to include one or more RAM modules mounted onto an integrated circuit board. In various embodiments, the one or more DIMMs 324 may be partitioned into a low region of memory, such as from 1 megabyte (MB) 326 to 1 gigabyte (GB) 328, and a high region of memory, such as from 1GB 328 to 4GB 330. In these embodiments, the amount of memory allocated to the low and high memory regions, the memory addresses within the one or more DIMMs 324 where such allocation may occur, and how such allocation may be performed, is a matter of design choice.

In various embodiments, the HDD/SDD memory 332 may be implemented to include an extensible firmware interface (EFI) system partition (ESP) 334. Skilled practitioners of the art will be familiar with an ESP 334, which is usually implemented as a partition on a mass storage device, such as HDD/SSD memory 332, which in turn is used by an associated IHS implemented with a Unified Extensible Firmware Interface (UEFI), described in greater detail herein. In such implementations, the UEFI loads files stored within the ESP 334 to begin installing Operating System (OS) and associated utility files. In various embodiments, the ESP 334 may be implemented to contain the boot loaders, or kernel images, for all installed OS’s that may be contained in other memory partitions, device driver files for hardware devices present in its associated IHS and used by the firmware at boot time, system utility programs that are intended to be run before a particular OS is booted, and data files such as error logs.

In various embodiments, the ASDFMP 300 may be implemented to include an OS runtime phase 304, and various pre-boot phases 310, all of which are described in greater detail herein. In various embodiments, the OS runtime phase 304 may be implemented to include a user mode 306 and a kernel mode 308, both of which are likewise described in greater detail herein. In various embodiments, certain components, processes, or operations, or a combination thereof, respectively associated with the OS runtime phase 304 and the pre-boot phases 310, may be implemented to interact with various components of the platform architecture 302, as likewise described in greater detail herein.

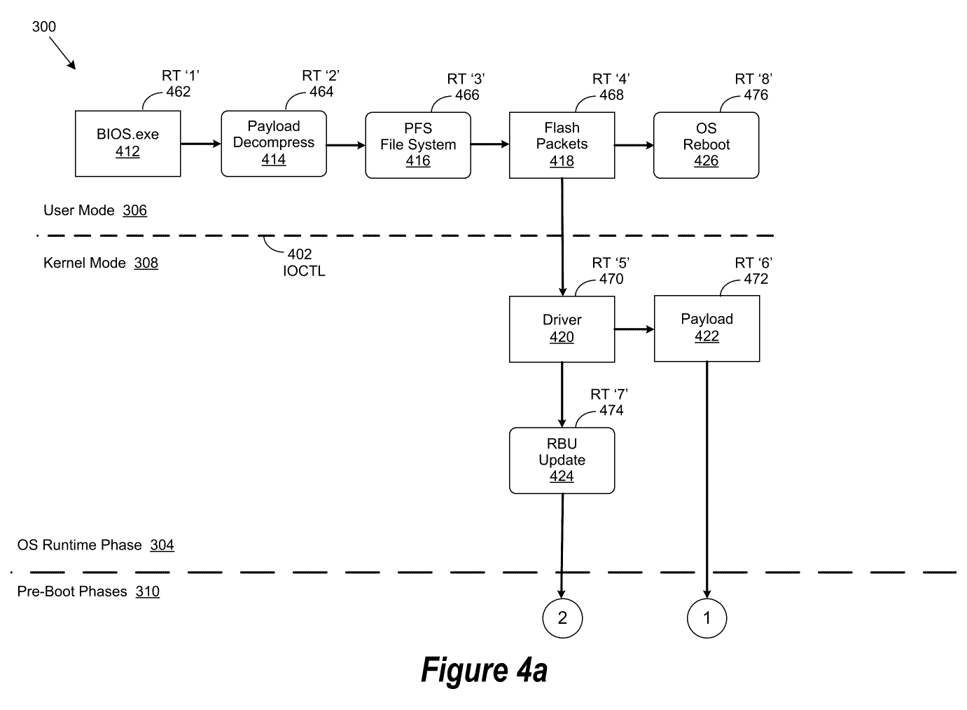

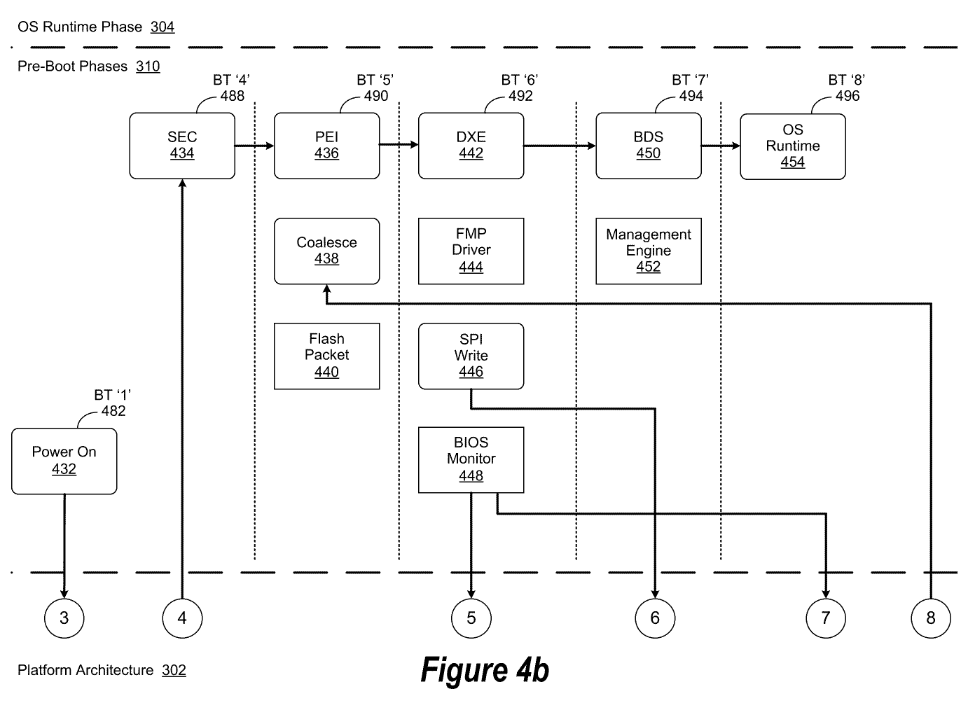

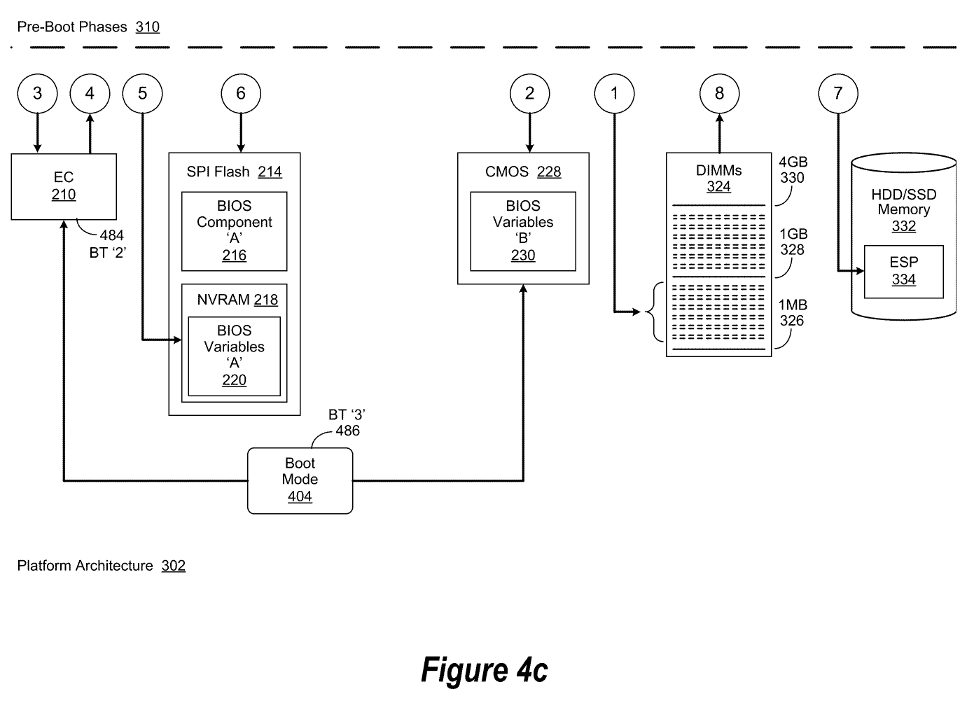

FIGS. 4a through 4c are a simplified block diagram showing an architecture-specific distributed firmware management platform (ASDFMP) implemented in accordance with an embodiment of the invention to perform certain distributed firmware management operations. In certain embodiments, the ASDFMP 300 may be implemented to include an Operating System (OS) runtime phase 304, various pre-boot phases 310, and a platform architecture 302. In various embodiments, as described in greater detail herein, the platform architecture 302 may be implemented to include an embedded controller (EC) 210, Serial Peripheral Interface (SPI) Flash 214 memory, and a complementary metal-oxide-semiconductor (CMOS) 228 chip, or a combination thereof. In various embodiments, the platform architecture 302 may likewise be implemented to include one or more dual in-line memory modules (DIMMs) 324, and certain hard disk drive (HDD) memory, or solid state drive (SSD) memory, or a combination of the two 332.

In various embodiments, the SPI Flash 214 memory may be implemented to receive, store, manage, and provide access to one or more Basic Input/Output System (BIOS) components ‘A’ 216, described in greater detail herein. In various embodiments, the SPI Flash 214 memory may likewise be implemented to include certain NVRAM 218 memory, likewise described in greater detail herein. In various embodiments, the NVRAM 218 memory may in turn be implemented to receive, store, manage, and provide access to one or more BIOS variables ‘A’ 220, as described in greater detail herein.

In various embodiments, the OS runtime phase 304 may be implemented to include a user mode 306 and a kernel mode 308. Skilled practitioners of the art will be aware that user mode 306 generally refers to a restricted mode that limits software access to system resources, while kernel mode 308 generally refers to a privileged mode that allows software to access system resources and perform privileged operations. In various embodiments, an Input/Output Control (IOCTL) 402 operation, familiar to those of skill in the art, may be performed to switch between user mode 306 and kernel mode 308. Those of skill in the art will likewise be aware that such mode switching generally involves saving the current context of an associated information handling system’s (IHS’s) processor in memory, switching to the new mode, and loading the new context into the processor.

Referring now to FIG. 4a, a distributed firmware management operation may be initiated by the ASDFMP 300 receiving a BIOS.exe 412 file in runtime (RT) step ‘1’ 462. In various embodiments, the BIOS.exe 412 file may be implemented as the combination of a flash memory utility and a payload of firmware components, described in greater detail herein. Then, in RT step ‘2’ 464 the BIOS.exe 412 is executed to decompress 414 its payload, which is then converted in RT step ‘3’ 466 into a payload file system (PFS) 416.

Flash memory packets 418 are then extracted from the PFS 416 if RT step ‘4’ 468 and provided to a memory driver 420 in RT step ‘5’ 470 to create a memory payload 422. The resulting memory payload 422 is then loaded into a lower memory region of one or more DIMMs 324, such as between 1 megabyte (MB) 326 and 1 gigabyte (GB) 328. Thereafter, a Remote BIOS Update (RBU) 424 operation may be performed in RT step ‘7’ to update certain BIOS variables ‘B’ 230 stored in the CMOS 328 chip. An OS reboot 426 operation is then performed in RT step ‘8’ 476.

Once the OS reboot 426 operation has been performed in RT step ‘8’ 476, power is applied 432 to the ASDFMP 300 in pre-boot time (BT) step ‘1’ 432. An embedded controller (EC) 210 is then invoked in BT step ‘2’ 464 which results in the activation of a boot mode 404 in BT step ‘3’ 486. In various embodiments, the boot mode 404 may be activated in BT step ‘3’ 486 by retrieving, and using, certain BIOS variables ‘B’ stored in the CMOS 228 chip.

One or more security (SEC) 434 phase operations may then be performed in BT step ‘4’ 488, followed by the performance of one or more Pre Extensible Firmware Interface (EFI) Initialization (PEI) 436 phase operations in BT step ‘5’ 490. In various embodiments, the one or more SEC 434 phase operations may be implemented to secure the boot process by preventing the loading of Unified Extensible Firmware Interface (UEFI) drivers, or boot loaders, that are not signed with an acceptable digital signature. In various embodiments, a trusted platform module (TPM), familiar to skilled practitioners of the art, may be used in the performance of one or more SEC 434 phase operations.

Those of skill in the art will likewise be aware that PEI 436 phase operations are generally performed to initialize permanent memory within a particular IHS to load and invoke initial configuration routines specific to its associated processor environment (PE), described in greater detail herein. In various embodiments, performance of the PEI 436 phase operation in BT step ‘5’ 490 may include one of more packet coalescing 438 operations being performed to coalesce individual flash memory packets previously stored in a low memory region of one or more DIMMs in RT step ‘6’ 472. In various embodiments, the individual flash memory packets may then be stored as one or more coalesced flash memory packets 440.

In various embodiments, a firmware management protocol (FMP) may be used in the performance of a Driver eXecution Environment (DXE) 442 phase operation in BT step 6’ 492 to perform an SPI write 446 operation to write the coalesced flash memory packets 440 to SPI Flash 214 memory. Skilled practitioners of the art will be familiar with a DXE 442, which as typically implemented includes a DXE Core, a DXE Dispatcher, and one or more Firmware Management Protocol (FMP) drivers 444. In general, the DXE Core component is responsible for producing a set of boot services, DXE services, and RT Services. Likewise, the DXE Dispatcher component is responsible for discovering and executing FMP drivers 444 in the correct order. In turn, the FMP drivers 444 are responsible for initializing the IHS’s processor environment (PE), described in greater detail herein. In various embodiments, the SPI write 446 operation may be performed to write certain flash memory packets associated with certain BIOS components ‘A’ 216, or certain BIOS variables ‘A’ 220, or a combination of the two. In various embodiments, the flash memory packets may contain new, updated, modified, revised, or replacement BIOS components ‘A’ 216, or BIOS variables ‘A’ 220, or a combination of the two.

In various embodiments, a BIOS monitor 448, such as BIOS IQ, produced by Dell^{®} Incorporated, of Round Rock, Texas, may be implemented within the DXE 442 phase to monitor the current values of certain BIOS variables ‘A’ 220 stored in NVRAM 218, which in certain embodiments, may be implemented within SPI Flash 214 memory. In various embodiments, the BIOS monitor 448 may likewise be implemented to monitor the status of certain data stored in the ESP 334, described in greater detail herein. Once DXE 442 phase operations are completed in BT step ‘6’ 494, the OS is then booted. In various embodiments, a boot device selection (BDS) 450 phase operation is then performed in BT step ‘7’ 494 to select a boot device. In various embodiments, a management engine (ME) 452, such as the ME 452 produced by Intel^{®} Corporation of Santa Clara, California, may be implemented to use the selected boot device in BT step ‘8’ 496 to boot the ASDFMP 300 into an OS runtime 454 state.

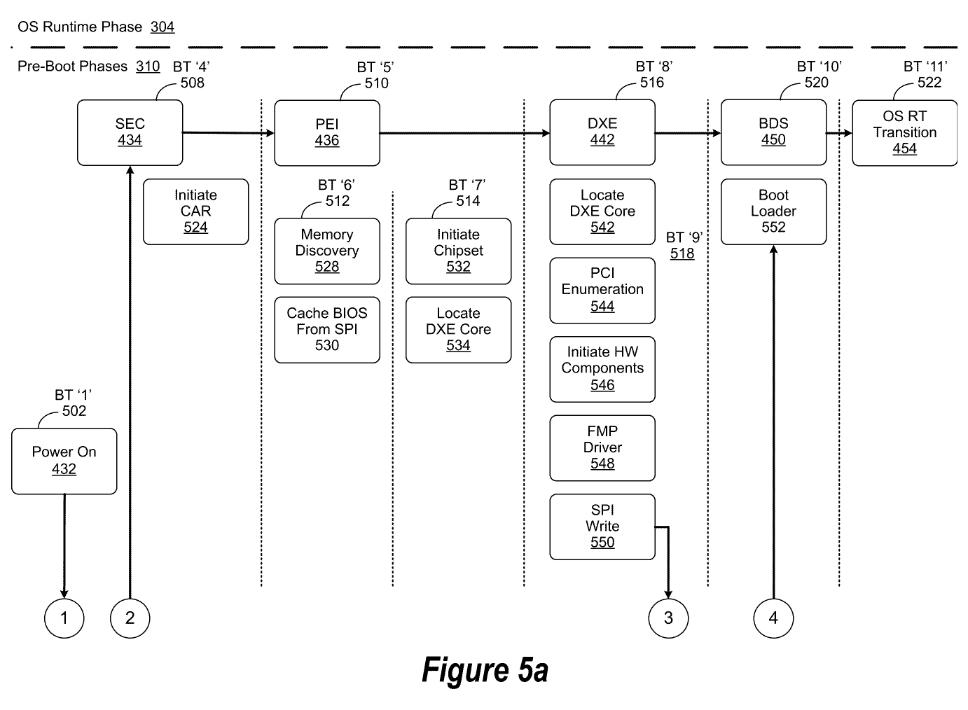

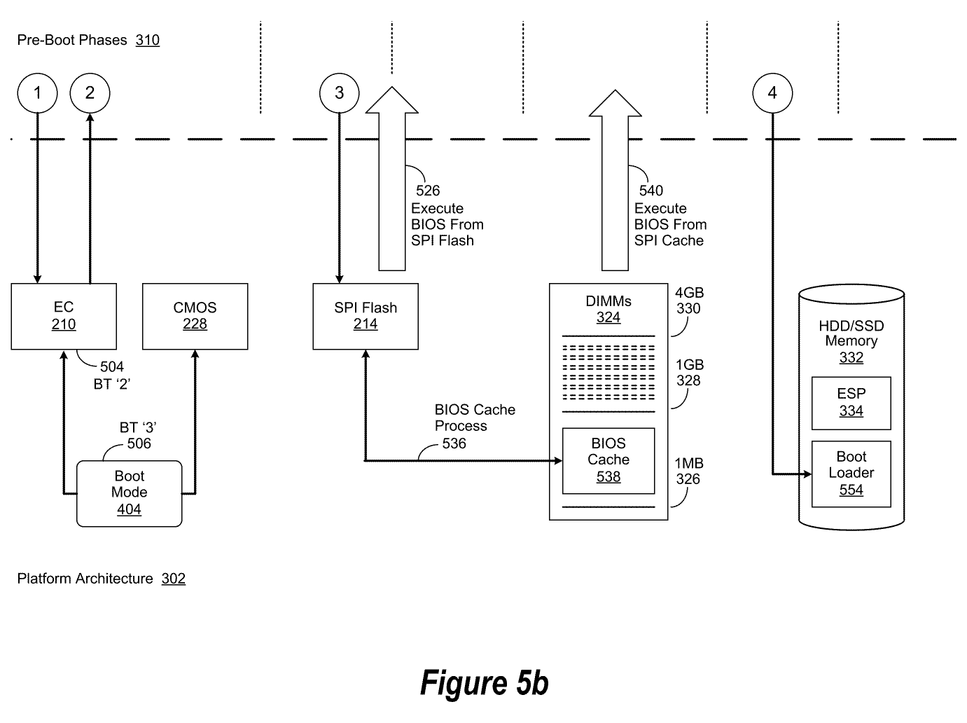

FIGS. 5a and 5b are a simplified block diagram showing the performance of certain boot path management operations implemented in accordance with an embodiment of the invention to boot an associated information handling system (IHS). Skilled practitioners of the art will be familiar with a boot path, also known as the boot sequence or boot order, which refers to the process by which an Operating System (OS) is loaded and initialized on an IHS. In general, a boot path involves three components. The first is a boot partition (BP), which is a designated volume on a storage device of the IHS, such as a hard drive 332 or an NVMe memory device (not shown), that contains the system files used to initiate the OS.

The BP is typically marked as active and contains a boot loader program, which is the second component of the boot path. As typically implemented, the boot loader program is used to load 536 the OS into a BIOS cache 536 within the main memory, such as DIMMs 324, of the IHS. The third component is the boot.ini, or Boot Configuration Data (BCD) store, which is a configuration file specifying boot options, including timeouts, default operating system, and a list of available operating systems.

As likewise used herein, a boot path definition broadly refers to the sequence of events that occur during the boot process of an associated IHS. In general, once the BIOS of the IHS has been initialized, it searches for a bootable device, such as a hard drive 332, a Universal Serial Bus (USB) drive, an NVMe memory device, and so forth. Once a bootable device has been identified, the BIOS loads the boot loader program from the BP, which then reads the boot.ini or BCD file to determine boot options. The boot loader then presents a menu of available OS’s to the user, who then selects which one to load, which is then loaded into main memory (e.g., DIMMs 324) and the boot process is completed. Accordingly, as used herein, a boot path management operation broadly refers to any function, task, procedure, or process performed, directly or indirectly, and the sequence in which they may respectively occur during the boot process of an associated IHS, to load and initialize a particular OS.

Various embodiments of the invention reflect an appreciation that it is not uncommon for an IHS to be implemented with an embedded controller (EC) 210, familiar to skilled practitioners of the art. Likewise, various embodiments of the invention reflect an appreciation that an EC 210, as typically implemented, may be used to perform a variety of IHS-related tasks. One such use is for the EC 210 to gain control of the IHS during the power-on 432 phase of its boot process and load the instruction pointer of its processor, which is then pointed to the location of its associated BIOS code within the SPI flash 214 memory of the IHS.

Accordingly, various embodiments of the invention reflect an appreciation that the IHS’s BIOS will execute directly from SPI flash 214 memory, as its Random Access Memory (RAM) and other memory has not yet been initialized. Likewise, Security (SEC) 434 pre-boot phase 310 code may be implemented in various embodiments to initialize the IHS’s chipset Cache as RAM (CAR), such that stack and heap operations can be performed. If so, then the BIOS of the IHS will execute directly from SPI 214 flash memory such that the IHS’s various memory components may be discovered and initialized during Pre Extensible Firmware Interface (EFI) Initialization (PEI) 436 pre-boot phase 310 operations. Thereafter, once the IHS’s memory components have been discovered and initialized, then its associated BIOS code may be cached 536 from SPI flash memory to a BIOS cache 538 allocated within the IHS’s RAM, such as one or more DIMMs 324.

However, various embodiments of the invention likewise reflect an appreciation that caching 536 SPI flash 214 memory content to an IHS’s main memory during every boot takes additional time (e.g., 500ms to 1 sec), since reading from SPI 214 flash memory can be time consuming. As a result, overall time for an IHS to boot may be increased. Likewise, various embodiments of the invention reflect an appreciation that there is currently no known approach for providing an intelligent, staged cache mechanism available as single compressed image residing in SPI flash memory. Accordingly, various aspects of the invention likewise reflect an appreciation that typical one-time caches 536 of an IHS’s entire BIOS may delay its boot, due to the inability to select only a predetermined portion of BIOS firmware for caching 536.

In various embodiments, one or more firmware components may be stored in volatile memory, or non-volatile memory, or a combination thereof, implemented within an IHS. In various embodiments, the non-volatile memory implemented within an IHS may include SPI flash 214 memory, or NVMe memory, or a combination thereof. In various embodiments, the non-volatile memory of an IHS may be implemented to include a boot partition (BP), described in greater detail herein. In certain of these embodiments, the one or more firmware components may be stored in a BP of an IHS’s non-volatile memory.

In various embodiments, copies of one or more firmware components may be stored in two or more memory storage locations of the IHS. As an example, one copy of a firmware component may be stored in an IHS’s RAM memory, while a second copy of the same firmware component may be stored in a BP implemented within its NVMe memory. In various embodiments, the memory location used to store a particular firmware component, and whether it is concurrently stored in more than one memory location, is a matter of design choice.

In various embodiments, a firmware component may be implemented as a BIOS image file, or one or more individual components thereof, or one or more individual firmware component files, or a combination thereof. In various embodiments, the determination of the sequence that each firmware component is executed during the boot sequence of an associated IHS, and the selection of the memory location it may be respectively stored in, is a matter of design choice. As an example, a copy of a particular firmware component stored in one memory location may be utilized in a first boot mode during the boot process of an associated IHS, while a copy of the same firmware component stored in another memory location may be utilized in a second boot mode.

Referring now to FIGS. 5a and 5b, an IHS may be implemented to include an OS runtime phase 304, various pre-boot phases 310, and a platform architecture 302. In various embodiments, the pre-boot phases 310 may include a security (SEC) 434 phase, a Pre Extensible Firmware Interface (EFI) Initialization (PEI) 436 phase, a Driver eXecution Environment (DXE) 442 phase, a boot device selection (BDS) 450, and an Operating System (OS) runtime 454 transition phase, as described in greater detail herein.

In various embodiments, as likewise described in greater detail herein, the platform architecture 302 may be implemented to include an embedded controller (EC) 210, SPI flash 214 memory, one or more dual in-line memory modules (DIMMs) 324, and certain hard disk drive (HDD) memory, or solid state drive (SSD) memory, or a combination of the two 332, or a combination thereof. In various embodiments, the SPI flash 214 memory may be implemented to receive, store, manage, and provide access to one or more BIOS components, described in greater detail herein. In various embodiments, the one or more DIMMs 324 may be implemented to include a BIOS cache 538. Likewise, the HDD/SDD 332 memory may be implemented in various embodiments to include an extensible firmware interface (EFI) system partition (ESP) 334, or a boot loader 554, or both, as described in greater detail herein.

In various embodiments, one or more boot path management operations may be initiated by the application of power 432 to the IHS in pre-boot time (BT) step ‘1’ 502. An embedded controller (EC) 210 is then invoked in BT step ‘2’ 504 which results in the activation of a boot mode 404 in BT step ‘3’ 506, as described in greater detail herein. One or more security (SEC) 434 pre-boot 310 phase operations may then be performed in BT step ‘4’ 508. In various embodiments, certain SEC 434 pre-boot phase 310 code may be implemented to initialize 524 the IHS’s chipset Cache as RAM (CAR), such that stack and heap operations can be performed.

In various embodiments, the IHS may be implemented to then enter a PEI 436 pre-boot 310 phase in BT step ‘5’ 510, as likewise described in greater detail herein. In various embodiments, one or more boot path management operations may likewise be performed during the PEI 436 phase in BT step ‘6’ 512 to discover 528 and initialize memory devices implemented within the IHS. Likewise, one or more boot path management operations may be performed in various embodiments in BT step ‘6’ 512 during the PEI 436 pre-boot 310 phase to cache 530 the BIOS of the IHS from where it is stored in SPI flash 214 memory to a BIOS cache 538, as described in greater detail herein. In various embodiments, one or more boot path management operations may be performed during the PEI 436 pre-boot 310 phase in BT step ‘7’ 514 to initialize 532 the chipset of the IHS. In various embodiments, one or more boot path management operations may likewise be performed during the PEI 436 phase in BT step ‘7’ 514 to locate 534 and initialize certain DXE 442 pre-boot 310 phase core components.

In various embodiments, the IHS may then be implemented to enter a DXE 442 pre-boot 310 phase in BT step ‘8’ 516. In various embodiments, one or more boot path management operations may likewise be performed during the DXE 442 pre-boot 310 phase in BT step ‘9’ 518 to verify the location 542 and initialization of certain DXE 442 pre-boot 310 phase core components. In various embodiments, one or more boot path management operations may likewise be performed during the DXE 442 pre-boot 310 phase in BT step ‘9’ 518 to locate, initialize, and enumerate 544 certain Peripheral Control Interface (PCI) components implemented on the IHS.

In various embodiments, one or more boot path management operations may likewise be performed during the DXE 442 pre-boot 310 phase in BT step ‘9’ 518 to initialize 546 certain hardware components implemented on the IHS. Likewise, one or more boot path management operations may likewise be performed in various embodiments, during the DXE 442 pre-boot 310 phase in BT step ‘9’ 518 to initiate 548 a Firmware Management Protocol (FMP) driver, familiar to skilled practitioners of the art. In various embodiments, one or more boot path management operations may likewise be performed during the DXE 442 pre-boot 310 phase in BT step ‘9’ 518 to write 550 a copy of the BIOS, or associated boot path information updates, or a combination of the two, to the SPI flash 214 memory. In various embodiments, one or more boot path management operations may likewise be performed during the BDS 450 pre-boot 310 phase in BT step ‘10’ 520 to initiate 552 a boot loader 554, described in greater detail herein. In various embodiments, one or more boot path management operation may be performed during the OS runtime transition 454 pre-boot 310 phase in BT step ‘11’ 522 to use the previously-initiated 522 boot loader 554 to execute the BIOS of the IHS from SPI flash 214 memory, or from the BIOS cache 538, or a combination of the two.

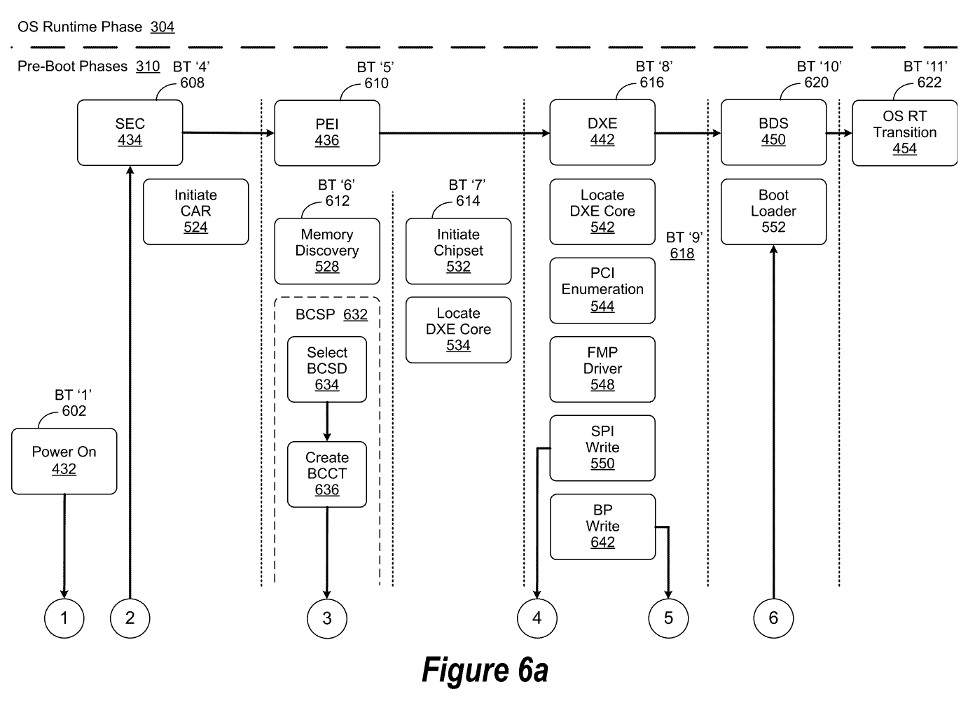

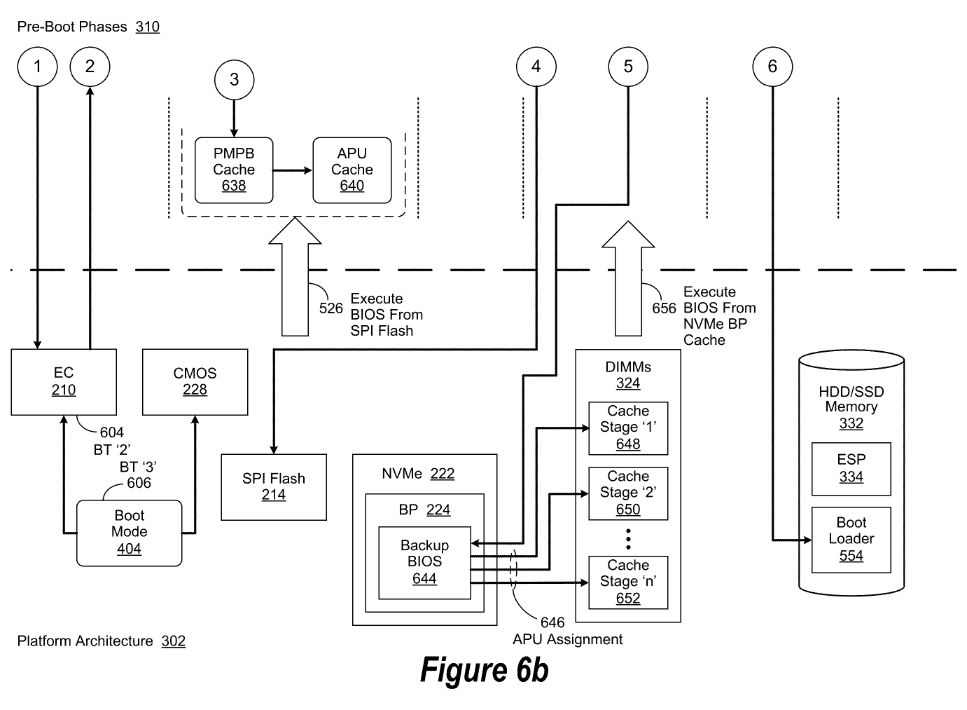

FIGS. 6a and 6b are a simplified block diagram showing the use of one or more boot path cache (BPC) operations implemented in accordance with an embodiment of the invention to facilitate the performance of certain boot path management operations. In various embodiments, an information handling system (IHS) may receive a Basic Input/Output System (BIOS) flash trigger instruction, which may in turn result in the performance of one of more BPC operations, described in greater detail herein. In certain of these embodiments, a flash memory driver, also commonly known to skilled practitioners of the art as a flash controller, may be used in the performance of the one or more BPC operations to flash a BIOS image, or an individual component thereof, or firmware component payload, or a combination of the two, to the IHS’s non-volatile memory.

In various embodiments, the IHS’s non-volatile memory may include Serial Peripheral Interface (SPI) flash memory and Non-Volatile Memory express (NVMe) memory. In various embodiments, the IHS’s NVMe memory may be implemented to include a boot partition (BP), described in greater detail herein. In various embodiments, one or more BPC operations may be performed to flash the same BIOS image, or an individual component thereof, or one or more individual firmware component files, or a combination thereof, to both the IHS’s SPI flash memory and its NVMe BP. Thereafter, once the IHS is powered on, a Boot Path Load Manager (BPLM), also commonly known as a boot loader, may be implemented in various embodiments to load the security (SEC) and Pre Extensible Firmware Interface (EFI) Initialization (PEI) pre-boot phase drivers from SPI memory to boot the IHS. Once the IHS’s memory discovered and initialized, the BPLM may then be implemented in certain of these embodiments to set the BIOS cache source device as its NVMe BP, from which Driver eXecution Environment (DXE) and System Management RAM (SMM) drivers can subsequently be loaded.

In various embodiments, one or more BPC operations may be performed to read the BIOS header from the NVMe BP and create a Boot Context Cache (BCC) table based upon the current boot mode of the IHS and its boot configuration. In various embodiments, the BCC table may be implemented to contain a list of portions of the BIOS to be cached for its current boot mode and corresponding execution boot phase. In various embodiments, one or more BPM operations may be performed to process the BCC table to generate a list of post-memory PEI phase BIOS portions to be cached. In certain of these embodiments, a Bootstrap Processor (BSP) may be used in the performance of the one or more BPM operations to cache individual post-memory PEI phase BIOS portions.

In various embodiment, one or more BPM operations may then be performed handover cache operation to multiprocessor (MP) services, which in certain embodiments may be implemented to assign other portions of the BIOS to associated Application Processor Units (APUs) to continue the IHS boot process. In certain of these embodiments, each APU may be implemented in parallel to use the BCC table to identify the portions of the BIOS used in the DXE and SMM phases. Various embodiments of the invention reflect an appreciation that the performance of such parallel operations facilitates avoidance of post-memory BIOS execution wait times.

Referring now to FIGS. 6a and 6b, an IHS may be implemented to include an OS runtime phase 304, various pre-boot phases 310, and a platform architecture 302. In various embodiments, the pre-boot phases 310 may include a security (SEC) 434 phase, a Pre Extensible Firmware Interface (EFI) Initialization (PEI) 436 phase, a Driver eXecution Environment (DXE) 442 phase, a boot device selection (BDS) 450, and an Operating System (OS) runtime 454 transition phase, as described in greater detail herein.

In various embodiments, as likewise described in greater detail herein, the platform architecture 302 may be implemented to include an embedded controller (EC) 210, SPI flash 214 memory, NVMe 222 memory, one or more dual in-line memory modules (DIMMs) 324, and certain hard disk drive (HDD) memory, or solid state drive (SSD) memory, or a combination of the two 332, or a combination thereof. In various embodiments, the SPI flash 214 memory may be implemented to receive, store, manage, and provide access to one or more BIOS components, described in greater detail herein.

In various embodiments, the NVMe 222 memory may be implemented to include a boot partition (BP) 224, described in greater detail herein. In certain of these embodiments, the BP 224 may be implemented to store a backup copy 644 of a BIOS for the IHS. In various embodiments, the one or more DIMMs 324 may be implemented to include one or more BIOS cache stage storage locations ‘1’ 648, and ‘2’ 650 through ‘n’ 652. Likewise, the HDD/SDD 332 memory may be implemented in various embodiments to include an extensible firmware interface (EFI) system partition (ESP) 334, or a boot loader 554, or both, as described in greater detail herein.

In various embodiments, one or more BPC operations may be initiated by the application of power 432 to the IHS in pre-boot time (BT) step ‘1’ 602. An embedded controller (EC) 210 is then invoked in BT step ‘2’ 604 which results in the activation of a boot mode 404 in BT step ‘3’ 606, as described in greater detail herein. One or more security (SEC) 434 pre-boot 310 phase operations may then be performed in BT step ‘4’ 608. In various embodiments, certain SEC 434 pre-boot phase 310 code may be implemented to initialize 524 the IHS’s chipset Cache as RAM (CAR), such that stack and heap operations can be performed.

In various embodiments, the IHS may be implemented to then enter a PEI 436 pre-boot 310 phase in BT step ‘5’ 610, as likewise described in greater detail herein. In various embodiments, one or more BPC operations may likewise be performed during the PEI 436 phase in BT step ‘6’ 612 to discover 528 and identify memory devices implemented within the IHS. In various embodiments, the IHS may be implemented to use a boot path smart cache protocol (BCSP) to perform one or more BCSP operations 632. As used herein, a boot path smart cache protocol broadly refers to a standardized set of rules for formatting and processing data used in the performance of a boot path cache operation. In certain embodiments, the boot path smart cache protocol is used when communicating with a processor such as an APU, an application, any of a plurality of processor components (such as the components described with respect to the multi-processor operating environment in FIG. 2), any of a plurality of peripheral components, or a combination thereof, regarding information associated with performance of a BPC operation. In various embodiments, a BCSP operation manages a BIOS cache source device via the boot path smart cache protocol.

Likewise, one or more BPC operations may be performed in various embodiments in BT step ‘6’ 612 during the PEI 436 pre-boot 310 phase to first select 634 a BIOS cache source device (BCSD), such as one or more DIMMs 324. Thereafter, one or more BPC operations may likewise be performed in various embodiments in BT step ‘6’ 612 during the PEI 436 pre-boot 310 phase to create 636 a BCC table, described in greater detail herein. In various embodiments, a BCSP operation 632 may include the selecting 634, the creating 636, or a combination thereof.

In various embodiments, the BIOS header of the BP 224 within the NVMe memory 522 may be used to create the BCC table. In various embodiments, the BCC table may be based on the IHS’s current boot mode and boot configuration. In various embodiments, the BCC table may be implemented to contain a list of BIOS sections, or components, to be cached for the current boot mode of the IHS and its execution boot phase.

Likewise, one or more BPC operations may be performed in various embodiments in BT step ‘6’ 612 during the PEI 436 pre-boot 310 phase to process the BCC table to determine 638 a list of post-memory PEI BIOS (PMPB) regions to be cached. In various embodiments, one or more BPC operations may likewise be performed in BT step ‘6’ 612 during the PEI 436 pre-boot 310 phase to handover 640 cache operation to a particular Application Processor Unit (APU). Likewise, one or more BPC operations may be performed in BT step ‘6’ 612 in various embodiments during the PEI 436 pre-boot 310 phase to use certain information contained in the BCC table to determine which BIOS information stored in cache stage storage locations ‘1’ 648, and ‘2’ 650 through ‘n’ 652 is assigned 646 to which APU. Various embodiments of the invention reflect an appreciation that such assignment may result in avoiding the need for post-memory BIOS execution to wait until all BIOS sections, or components, are cached. In various embodiments, a BCSP operation 632 may include the determining 638, the handover 640, or a combination thereof.

In various embodiments, one or more BPC operations may be performed during the PEI 436 pre-boot 310 phase in BT step ‘7’ 514 to initialize 532 the chipset of the IHS. In various embodiments, one or more BPC operations may likewise be performed during the PEI 436 phase in BT step ‘7’ 514 to locate 534 and initialize certain DXE 442 pre-boot 310 phase core components. In various embodiments, the IHS may then be implemented to enter a DXE 442 pre-boot 310 phase in BT step ‘8’ 516. In various embodiments, one or more boot path management operations may likewise be performed during the DXE 442 pre-boot 310 phase in BT step ‘9’ 518 to verify the location 542 and identity of certain DXE 442 pre-boot 310 phase core components. In various embodiments, one or more boot path management operations may likewise be performed during the DXE 442 pre-boot 310 phase in BT step ‘9’ 518 to locate, identify, and enumerate 544 certain Peripheral Control Interface (PCI) components implemented on the IHS.

In various embodiments, one or more boot path management operations may likewise be performed during the DXE 442 pre-boot 310 phase in BT step ‘9’ 518 to initialize 546 certain hardware components implemented on the IHS. Likewise, one or more boot path management operations may likewise be performed in various embodiments, during the DXE 442 pre-boot 310 phase in BT step ‘9’ 518 to initialize 548 a Firmware Management Protocol (FMP) driver, familiar to skilled practitioners of the art. In various embodiments, one or more boot path management operations may likewise be performed during the DXE 442 pre-boot 310 phase in BT step ‘9’ 518 to write 550 a copy of the BIOS, or associated boot path information updates, or a combination of the two, to the SPI flash 214 memory. In various embodiments, one or more boot path management operations may likewise be performed during the BDS 450 pre-boot 310 phase in BT step ‘10’ 520 to initialize 552 a boot loader 554, described in greater detail herein. In various embodiments, one or more boot path management operation may be performed during the OS runtime transition 454 pre-boot 310 phase in BT step ‘11’ 522 to use the previously-initialized 522 boot loader 554 to execute the BIOS of the IHS from SPI flash 214 memory, or from the NVMe BP cache 656, or a combination of the two.

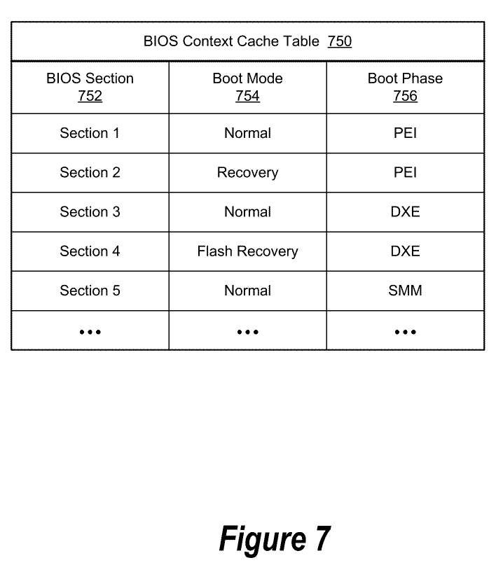

FIG. 7 shows a Basic Input/Output System (BIOS) context cache table implemented in accordance with an embodiment of the invention to facilitate the performance of certain boot path cache (BPC) operations. In various embodiments, one or more boot path cache (BPC) operations, described in greater detail herein, may be performed to generate a boot context cache (BCC) table 750. In various embodiments, the BCC table 750 may be implemented to contain information associated with a particular section 752, or component, of BIOS code. In various embodiments, the BCC table ma likewise be implemented to contain information related to a particular boot mode 754, or boot phase 756, or both, respectively associated with each section 752, or component, of BIOS code.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for performing a firmware management operation, comprising:
providing an information handling system with a distributed unified BIOS, the distributed unified BIOS comprising a firmware component;
identifying a processor environment installed on an information handling system from a plurality of processor environments, the processor environment comprising a processor architecture; and,
performing a boot path management operation, the boot path management operation managing a memory storage location of the firmware component during an information handling system boot process.

2. The method of claim 1, wherein:
the boot path management operation performs a boot path smart cache protocol operation, the boot path smart cache protocol operation managing a BIOS cache source device via a boot path smart cache protocol.

3. The method of claim 2, wherein:
the boot path smart cache protocol operation creates a BIOS context cache table.

4. The method of claim 3, wherein:
the BIOS context cache table includes a BIOS section portion, a boot mode portion and a boot phase portion.

5. The method of claim 1, wherein:
the boot path management operation hands over cache operations to multiprocessor services executing on the information handling system.

6. The method of claim 5, wherein:
the boot path management operation assigns portions of the distributed unified BIOS to associated Application Processor Units of the information handling system.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
providing an information handling system with a distributed BIOS;
identifying a processor environment installed on an information handling system from a plurality of processor environments;
performing a boot path management operation, the boot path management operation managing a memory storage location of the firmware component during an information handling system boot process.

8. The system of claim 7, wherein:
the boot path management operation performs a boot path smart cache protocol operation, the boot path smart cache protocol operation managing a BIOS cache source device via a boot path smart cache protocol.

9. The system of claim 8, wherein:
the boot path smart cache protocol operation creates a BIOS context cache table.

10. The system of claim 9, wherein:
the BIOS context cache table includes a BIOS section portion, a boot mode portion and a boot phase portion.

11. The system of claim 7, wherein:
the boot path management operation hands over cache operations to multiprocessor services executing on the information handling system.

12. The system of claim 11, wherein:
the boot path management operation assigns portions of the distributed unified BIOS to associated Application Processor Units of the information handling system.

13. A non-transitory, computer-readable storage medium embodying computer program code, the computer program code comprising computer executable instructions configured for:
providing an information handling system with a distributed BIOS;
identifying a processor environment installed on an information handling system from a plurality of processor environments;
performing a boot path management operation, the boot path management operation managing a memory storage location of the firmware component during an information handling system boot process.

14. The non-transitory, computer-readable storage medium of claim 13, wherein:
the boot path management operation performs a boot path smart cache protocol operation, the boot path smart cache protocol operation managing a BIOS cache source device via a boot path smart cache protocol.

15. The non-transitory, computer-readable storage medium of claim 14, wherein:
the boot path smart cache protocol operation creates a BIOS context cache table.

16. The non-transitory, computer-readable storage medium of claim 15, wherein:
the BIOS context cache table includes a BIOS section portion, a boot mode portion and a boot phase portion.

17. The non-transitory, computer-readable storage medium of claim 13, wherein:
the boot path management operation hands over cache operations to multiprocessor services executing on the information handling system.

18. The non-transitory, computer-readable storage medium of claim 17, wherein:
the boot path management operation assigns portions of the distributed unified BIOS to associated Application Processor Units of the information handling system.

19. The non-transitory, computer-readable storage medium of claim 13, wherein:
the computer executable instructions are deployable to a client system from a server system at a remote location.

20. The non-transitory, computer-readable storage medium of claim 13, wherein:
the computer executable instructions are provided by a service provider to a user on an on-demand basis.
